(19) United States
(12) Patent Application Publication
(10) Pub. No.: US 2008/0222545 A1
(43) Pub. Date: Sep. 11, 2008

(54) Portable Electronic Device with a Global Setting User Interface

(76) Inventors: Stephen O. Lemay, San Francisco, CA (US); Greg Christie, San Jose, CA (US); Scott Forstall, Mountain View, CA (US); Michael Matas, Palo Alto, CA (US); Marcel Van Os, San Francisco, CA (US); Imran Chaudhri, San Francisco, CA (US)

Correspondence Address: MORGAN LEWIS & BOCKIUS LLP/ AI, 2 PALO ALTO SQUARE, 3000 EL CAMINO REAL, PALO ALTO, CA, 94306, US

(21) Appl. No.: 11/960,669

(22) Filed: Dec. 19, 2007

Related U.S. Application Data
(60) Provisional application No. 60/937,993, filed on Jun. 29, 2007.
(60) Provisional application No. 60/879,469, filed on Jan. 8, 2007.
(60) Provisional application No. 60/879,253, filed on Jan. 7, 2007.
(60) Provisional application No. 60/883,812, filed on Jan. 7, 2007.

(51) Int. Cl. G06F 3/048

(52) U.S. Cl. 715/765

(57) ABSTRACT

A portable electronic device with a global setting user interface on a touch screen display is disclosed. The user interface has a plurality of application icons. In response to a first gesture, the GUI changes the appearances of the application icons whose corresponding applications have user-adjustable settings. In response to a second gesture on a selected application icon whose appearance is changed, the GUI displays user-adjustable settings of an application that corresponds to the selected application icon. In response to one or more additional gestures, the GUI changes one or more user-adjustable settings of the application that corresponds to the selected application icon.

### RELATED APPLICATIONS

This application claims priority to U.S. Provisional Patent Application No. 60/937,993, “Portable Multifunction Device,” filed Jun. 29, 2007; 60/879,469, “Portable Multifunction Device,” filed Jan. 8, 2007; 60/879,253, “Portable Multifunction Device,” filed Jan. 7, 2007; and 60/883,812, “Portable Electronic Device with a Global Setting User Interface” filed Jan. 7, 2007. All of these applications are incorporated by reference herein in their entirety.

This application is related to the following applications: (1) U.S. patent application Ser. No. 10/188,182, “Touch Pad For Handheld Device,” filed on Jul. 1, 2002; (2) U.S. patent application Ser. No. 10/722,948, “Touch Pad For Handheld Device,” filed on Nov. 25, 2003; (3) U.S. patent application Ser. No. 10/643,256, “Movable Touch Pad With Added Functionality,” filed on Aug. 18, 2003; (4) U.S. patent application Ser. No. 10/654,108, “Ambidextrous Mouse,” filed on Sep. 2, 2003; (5) U.S. patent application Ser. No. 10/840,862, “Multipoint Touchscreen,” filed on May 6, 2004; (6) U.S. patent application Ser. No. 10/903,964, “Gestures For Touch Sensitive Input Devices,” filed on Jul. 30, 2004; (7) U.S. patent application Ser. No. 11/038,590, “Mode-Based Graphical User Interfaces For Touch Sensitive Input Devices” filed on Jan. 18, 2005; (8) U.S. patent application Ser. No. 11/057,050, “Display Actuator,” filed on Feb. 11, 2005; (9) U.S. Provisional Patent Application No. 60/658,777, “Multi-Functional Hand-Held Device,” filed Mar. 4, 2005; (10) U.S. patent application Ser. No. 11/367,749, “Multi-Functional Hand-Held Device,” filed Mar. 3, 2006; and (11) U.S. Provisional Patent Application No. 60/824,769, “Portable Multifunction Device,” filed Sep. 6, 2006. All of these applications are incorporated by reference herein in their entirety.

### TECHNICAL FIELD

The disclosed embodiments relate generally to portable electronic devices, and more particularly, to a portable electronic device that is capable of performing instant messaging.

### BACKGROUND

As portable electronic devices become more compact, and the number of functions performed by a given device increase, it has become a significant challenge to design a user interface that allows users to easily configure a multifunction device. For example, some functions are user-configurable and some other functions are not. Without such information in advance, a user has to manually cycle through each individual function in order to configure the device to the user's preference.

This challenge is particular significant for handheld portable electronic devices, which have much smaller screens than desktop or laptop computers. This situation is unfortunate because the user interface is the gateway through which users receive not only content but also responses to user actions or behaviors, including user attempts to access a device's features, tools, and functions.

Accordingly, there is a need for portable electronic devices that provide transparent and intuitive global user-configuration user interfaces.

### SUMMARY

The above deficiencies and other problems associated with known portable devices are reduced or eliminated by the disclosed portable multifunction device. In some embodiments, the portable electronic device has a touch-sensitive display (also known as a “touch screen” or “touch screen display”) with a graphical user interface (GUI), one or more processors, memory and one or more modules, programs or sets of instructions stored in the memory for performing multiple functions. In some embodiments, the user interacts with the GUI primarily through finger contacts and gestures on the touch-sensitive display. Instructions for performing operations may be included in a computer program product configured for execution by one or more processors.

One aspect of the invention involves a computer-implemented method in which a portable electronic device with a touch screen: displays a plurality of application icons on the touch screen; changes the appearance of the application icons whose corresponding applications have user-adjustable settings upon detecting a first gesture on the touch screen; displays user-adjustable settings of an application that corresponds to an application icon upon detecting a second gesture on the application icon; and changes one or more settings of the application that corresponds to the selected application icon upon detecting one or more additional gestures to change one or more settings of the application.

Another aspect of the invention involves a computer-implemented method in which a portable electronic device with a touch screen: displays a plurality of application icons on the touch screen; changes the appearance of the application icons whose corresponding applications have no user-adjustable settings upon detecting a first gesture on the touch screen; displays user-adjustable settings of an application that corresponds to an application icon upon detecting a second gesture on the application icon; and changes one or more user-adjustable settings of the application that corresponds to the selected application icon upon detecting one or more additional gestures to change one or more user-adjustable settings of the application.

Another aspect of the invention involves a graphical user interface (GUI) on a portable electronic device with a touch screen display. The GUI has a plurality of application icons. In response to a first gesture, the GUI changes the appearances of the application icons whose corresponding applications have user-adjustable settings. In response to a second gesture on a selected application icon whose appearance is changed, the GUI displays user-adjustable settings of an application that corresponds to the selected application icon. In response to one or more additional gestures, the GUI changes one or more user-adjustable settings of the application that corresponds to the selected application icon.

Another aspect of the invention involves a portable electronic device. The device includes a touch screen display, one or more processors, memory, and one or more programs. The one or more program are stored in the memory and configured to be executed by the one or more processors. The one or more programs include: instructions for displaying a plurality of application icons on the touch screen display; instructions for changing the appearance of the application icons whose corresponding applications have user-adjustable settings upon detecting a first gesture on the touch screen display; instructions for displaying user-adjustable settings of an application that corresponds to an application icon upon detecting a second gesture on the application icon; and instructions for changing one or more settings of the application that corresponds to the selected application icon upon detecting one or more additional gestures to change one or more settings of the application.

Another aspect of the invention involves a computer readable storage medium storing one or more programs to be executed by a computer or other device. The one or more programs include: instructions for displaying a plurality of application icons on the touch screen display; instructions for changing the appearance of the application icons whose corresponding applications have user-adjustable settings upon detecting a first gesture on the touch screen display; instructions for displaying user-adjustable settings of an application that corresponds to an application icon upon detecting a second gesture on the application icon; and instructions for changing one or more settings of the application that corresponds to the selected application icon upon detecting one or more additional gestures to change one or more settings of the application.

Another aspect of the invention involves a portable electronic device with a touch screen display, comprising: means for displaying a plurality of application icons on the touch screen display; means for changing the appearance of the application icons whose corresponding applications have user-adjustable settings upon detecting a first gesture on the touch screen display; means for displaying user-adjustable settings of an application that corresponds to an application icon upon detecting a second gesture on the application icon; and means for changing one or more settings of the application that corresponds to the selected application icon upon detecting one or more additional gestures to change one or more settings of the application.

Thus, the invention provides a transparent and intuitive user interface for finding and changing application settings on a portable electronic device with a touch screen display.

### BRIEF DESCRIPTION OF THE DRAWINGS

For a better understanding of the aforementioned embodiments of the invention as well as additional embodiments thereof, reference should be made to the Description of Embodiments below, in conjunction with the following drawings in which like reference numerals refer to corresponding parts throughout the figures.

FIG. 1 is a block diagram illustrating a portable electronic device with a touch-sensitive display in accordance with some embodiments.

FIG. 2 illustrates a portable electronic device having a touch screen in accordance with some embodiments.

FIG. 3 illustrates an exemplary user interface for unlocking a portable electronic device in accordance with some embodiments.

FIG. 4 illustrates an exemplary user interface for a menu of applications on a portable electronic device in accordance with some embodiments.

FIG. 5A illustrates an exemplary user interface for flipping application icons having user-adjustable settings on a portable electronic device in accordance with some embodiments.

FIG. 5B illustrates an exemplary user interface for displaying both application icons with and without user-adjustable settings in visually distinguished manners on a portable electronic device in accordance with some embodiments.

FIG. 5C illustrates an exemplary user interface for displaying application icons with user-adjustable settings in a visually distinguished manner on a portable electronic device in accordance with some embodiments.

FIG. 5D illustrates an exemplary user interface for displaying only application icons with user-adjustable settings on a portable electronic device in accordance with some embodiments.

FIG. 6 illustrates an exemplary user interface for setting email user preferences in accordance with some embodiments.

FIG. 7 illustrates an exemplary user interface for setting user preferences in accordance with some embodiments.

FIG. 8 is a flowchart illustrating a process for rendering user setting interfaces on a portable electronic device's touch screen in accordance with some embodiments.

### DESCRIPTION OF EMBODIMENTS

Reference will now be made in detail to embodiments, examples of which are illustrated in the accompanying drawings. In the following detailed description, numerous specific details are set forth in order to provide a thorough understanding of the present invention. However, it will be apparent to one of ordinary skill in the art that the present invention may be practiced without these specific details. In other instances, well-known methods, procedures, components, circuits, and networks have not been described in detail so as not to unnecessarily obscure aspects of the embodiments.

Embodiments of a portable electronic device, user interfaces for such devices, and associated processes for using such devices are described. In some embodiments, the device is a portable communications device such as a mobile telephone that also contains other functions, such as PDA and/or music player functions.

The user interface may include a click wheel in addition to a touch screen. A click wheel is a physical user-interface device that may provide navigation commands based on an angular displacement of the wheel or a point of contact with the wheel by a user of the device. A click wheel may also be used to provide a user command corresponding to selection of one or more items, for example, when the user of the device presses down on at least a portion of the wheel or the center of the wheel. For simplicity, in the discussion that follows, a portable electronic device that includes a touch screen is used as an exemplary embodiment. It should be understood, however, that some of the user interfaces and associated processes may be applied to other devices, such as personal computers and laptop computers, which may include one or more other physical user-interface devices, such as a click wheel, a physical keyboard, a mouse and/or a joystick.

The device supports a variety of applications, such as a telephone application, a video conferencing application, an e-mail application, an instant messaging application, a blogging application, a digital camera application, a digital video camera application, a web browsing application, a digital music player application, and/or a digital video player application.

The various applications that may be executed on the device may use at least one common physical user-interface device, such as the touch screen. One or more functions of the touch screen as well as corresponding information displayed on the device may be adjusted and/or varied from one application to the next and/or within a respective application. In this way, a common physical architecture (such as the touch screen) of the device may support the variety of applications with user interfaces that are intuitive and transparent.

The user interfaces may include one or more soft keyboard embodiments. The soft keyboard embodiments may include standard (QWERTY) and/or non-standard configurations of symbols on the displayed icons of the keyboard, such as those described in U.S. patent applications Ser. No. 11/459,606, “Keyboards For Portable Electronic Devices,” filed Jul. 24, 2006, and Ser. No. 11/459,615, “Touch Screen Keyboards For Portable Electronic Devices,” filed Jul. 24, 2006, the contents of which are hereby incorporated by reference in their entirety. The keyboard embodiments may include a reduced number of icons (or soft keys) relative to the number of keys in existing physical keyboards, such as that for a typewriter. This may make it easier for users to select one or more icons in the keyboard, and thus, one or more corresponding symbols. The keyboard embodiments may be adaptive. For example, displayed icons may be modified in accordance with user actions, such as selecting one or more icons and/or one or more corresponding symbols. One or more applications on the portable electronic device may utilize common and/or different keyboard embodiments. Thus, the keyboard embodiment used may be tailored to at least some of the applications. In some embodiments, one or more keyboard embodiments may be tailored to a respective user. For example, based on a word usage history (lexicography, slang, individual usage) of the respective user. Some of the keyboard embodiments may be adjusted to reduce a probability of a user error when selecting one or more icons, and thus one or more symbols, when using the soft keyboard embodiments.

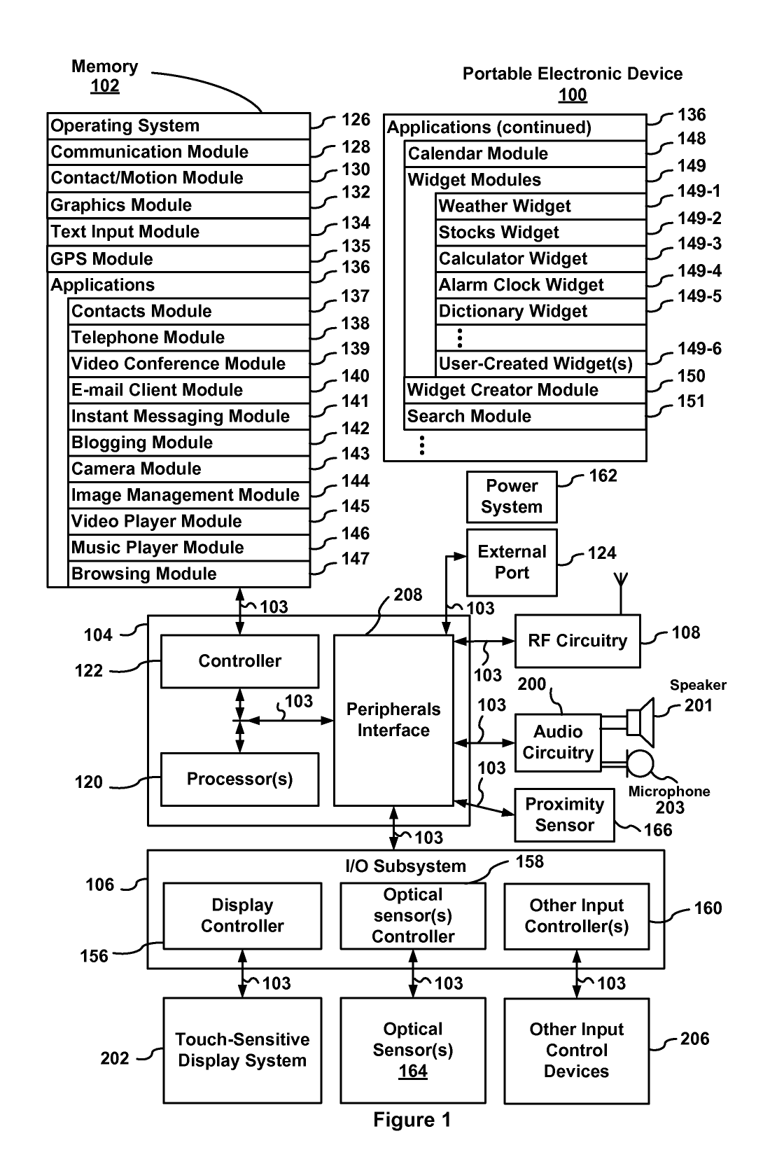

Attention is now directed towards embodiments of the device. FIG. 1 is a block diagram illustrating a portable electronic device 100 with a touch-sensitive display 112 in accordance with some embodiments. The touch-sensitive display 112 is sometimes called a “touch screen” for convenience. The device 100 may include a memory 102 (which may include one or more computer readable storage mediums), a memory controller 122, one or more processing units (CPU's) 120, a peripherals interface 118, RF circuitry 108, audio circuitry 110, a speaker 111, a microphone 113, an input/output (I/O) subsystem 106, other input or control devices 116, and an external port 124. The device 100 may include one or more optical sensors 164. These components may communicate over one or more communication buses or signal lines 103.

It should be appreciated that the device 100 is only one example of a portable electronic device 100, and that the device 100 may have more or fewer components than shown, may combine two or more components, or a may have a different configuration or arrangement of the components. The various components shown in FIG. 1 may be implemented in hardware, software or a combination of hardware and software, including one or more signal processing and/or application specific integrated circuits.

Memory 102 includes one or more memory devices, each of which comprises, or a plurality of which collectively comprise a computer readable storage medium. Memory 102 may include high-speed random access memory and may also include non-volatile memory, such as one or more magnetic disk storage devices, optical disk storage devices, flash memory devices, or other non-volatile solid-state memory devices. Access to memory 102 by other components of the device 100, such as the CPU 120 and the peripherals interface 118, may be controlled by the memory controller 122.

The peripherals interface 118 couples the input and output peripherals of the device to the CPU 120 and memory 102. The one or more processors 120 run or execute various software programs and/or sets of instructions stored in memory 102 to perform various functions for the device 100 and to process data.

In some embodiments, the peripherals interface 118, the CPU 120, and the memory controller 122 may be implemented on a single chip, such as a chip 104. In some other embodiments, they may be implemented on separate chips.

The RF (radio frequency) circuitry 108 receives and sends RF signals, also called electromagnetic signals. The RF circuitry 108 converts electrical signals to/from electromagnetic signals and communicates with communications networks and other communications devices via the electromagnetic signals. The RF circuitry 108 may include well-known circuitry for performing these functions, including but not limited to an antenna system, an RF transceiver, one or more amplifiers, a tuner, one or more oscillators, a digital signal processor, a CODEC chipset, a subscriber identity module (SIM) card, memory, and so forth. The RF circuitry 108 may communicate with networks, such as the Internet, also referred to as the World Wide Web (WWW), an intranet and/or a wireless network, such as a cellular telephone network, a wireless local area network (LAN) and/or a metropolitan area network (MAN), and other devices by wireless communication. The wireless communication may use any of a plurality of communications standards, protocols and technologies, including but not limited to Global System for Mobile Communications (GSM), Enhanced Data GSM Environment (EDGE), wideband code division multiple access (W-CDMA), code division multiple access (CDMA), time division multiple access (TDMA), Bluetooth, Wireless Fidelity (Wi-Fi) (e.g., IEEE 802.11a, IEEE 802.11b, IEEE 802.11g and/or IEEE 802.11n), voice over Internet Protocol (VoIP), Wi-MAX, a protocol for email, instant messaging, and/or Short Message Service (SMS)), or any other suitable communication protocol, including communication protocols not yet developed as of the filing date of this document.

The audio circuitry 110, the speaker 111, and the microphone 113 provide an audio interface between a user and the device 100. The audio circuitry 110 receives audio data from the peripherals interface 118, converts the audio data to an electrical signal, and transmits the electrical signal to the speaker 111. The speaker 111 converts the electrical signal to human-audible sound waves. The audio circuitry 110 also receives electrical signals converted by the microphone 113 from sound waves. The audio circuitry 110 converts the electrical signal to audio data and transmits the audio data to the peripherals interface 118 for processing. Audio data may be retrieved from and/or transmitted to memory 102 and/or the RF circuitry 108 by the peripherals interface 118. In some embodiments, the audio circuitry 110 also includes a headset jack (not shown). The headset jack provides an interface between the audio circuitry 110 and removable audio input/output peripherals, such as output-only headphones or a headset with both output (e.g., a headphone for one or both ears) and input (e.g., a microphone).

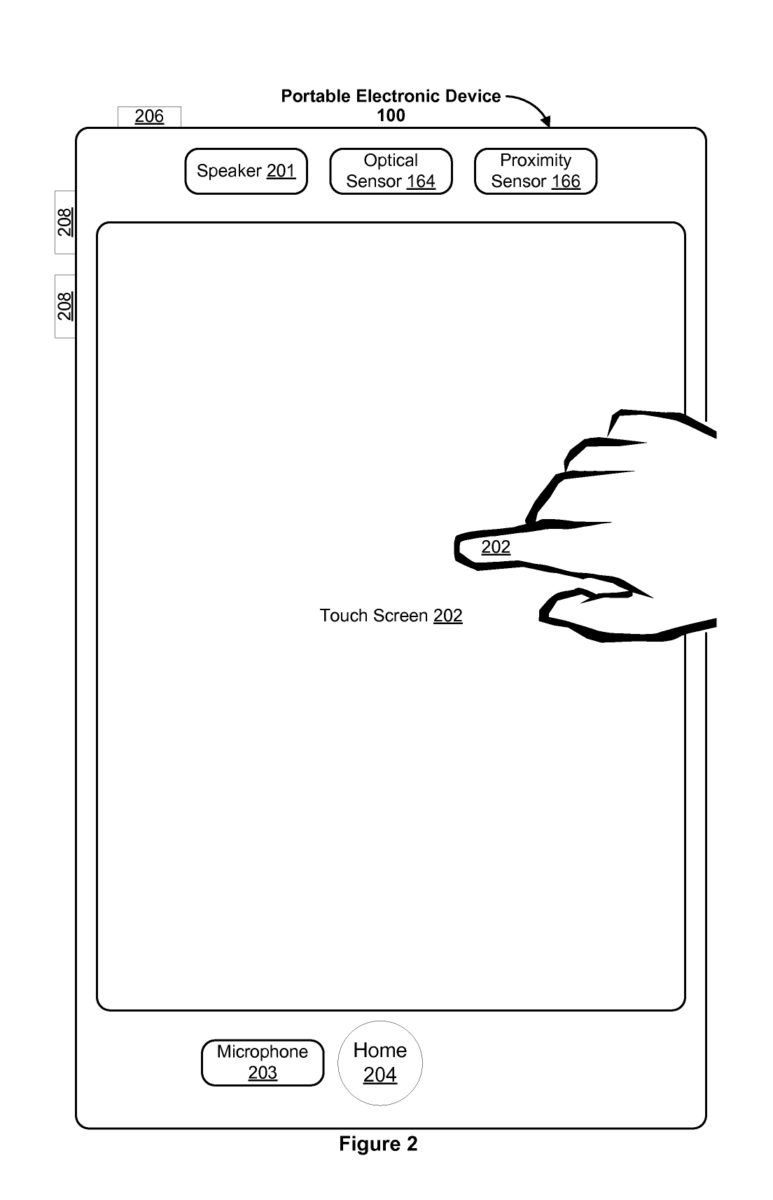

The I/O subsystem 106 couples input/output peripherals on the device 100, such as the touch screen 112 and other input/control devices 116, to the peripherals interface 118. The I/O subsystem 106 may include a display controller 156 and one or more input controllers 160 for other input or control devices. The one or more input controllers 160 receive/send electrical signals from/to other input or control devices 116. The other input/control devices 1160 may include physical buttons (e.g., push buttons, rocker buttons, etc.), dials, slider switches, joysticks, click wheels, and so forth. In some alternate embodiments, input controller(s) 160 may be coupled to any (or none) of the following: a keyboard, infrared port, USB port, and a pointer device such as a mouse. The one or more buttons (e.g., 208, FIG. 2) may include an up/down button for volume control of the speaker 111 and/or the microphone 113. The one or more buttons may include a push button (e.g., 206, FIG. 2). A quick press of the push button may disengage a lock of the touch screen 112 or begin a process that uses gestures on the touch screen to unlock the device, as described in U.S. patent application Ser. No. 11/322,549, “Unlocking a Device by Performing Gestures on an Unlock Image,” filed Dec. 23, 2005, which is hereby incorporated by reference in its entirety. A longer press of the push button (e.g., 206) may turn power to the device 100 on or off. The user may be able to customize a functionality of one or more of the buttons. The touch screen 112 is used to implement virtual or soft buttons and one or more soft keyboards.

The touch-sensitive touch screen 112 provides an input interface and an output interface between the device and a user. The display controller 156 receives and/or sends electrical signals from/to the touch screen 112. The touch screen 112 displays visual output to the user. The visual output may include graphics, text, icons, video, and any combination thereof (collectively termed “graphics”). In some embodiments, some or all of the visual output may correspond to user-interface objects, further details of which are described below.

A touch screen 112 has a touch-sensitive surface, sensor or set of sensors that accepts input from the user based on haptic and/or tactile contact. The touch screen 112 and the display controller 156 (along with any associated modules and/or sets of instructions in memory 102) detect contact (and any movement or breaking of the contact) on the touch screen 112 and converts the detected contact into interaction with user-interface objects (e.g., one or more soft keys, icons, web pages or images) that are displayed on the touch screen. In an exemplary embodiment, a point of contact between a touch screen 112 and the user corresponds to a finger of the user.

The touch screen 112 may use LCD (liquid crystal display) technology, or LPD (light emitting polymer display) technology, although other display technologies may be used in other embodiments. The touch screen 112 and the display controller 156 may detect contact and any movement or breaking thereof using any of a plurality of touch sensing technologies now known or later developed, including but not limited to capacitive, resistive, infrared, and surface acoustic wave technologies, as well as other proximity sensor arrays or other elements for determining one or more points of contact with a touch screen 112. A touch-sensitive display in some embodiments of the touch screen 112 may be analogous to the multi-touch sensitive tablets described in the following U.S. Pat. No. 6,323,846 (Westerman et al.), U.S. Pat. No. 6,570,557 (Westerman et al.), and/or U.S. Pat. No. 6,677,932 (Westerman), and/or U.S. Patent Publication 2002/0015024A1, each of which is hereby incorporated by reference in its entirety. However, a touch screen 112 displays visual output from the portable electronic device 100, whereas touch sensitive tablets do not provide visual output. The touch screen 112 may have a resolution in excess of 100 dpi. In an exemplary embodiment, the touch screen in the display system has a resolution of approximately 168 dpi. The user may make contact with the touch screen 112 using any suitable object or appendage, such as a stylus, a finger, and so forth. In some embodiments, the user interface is designed to work primarily with finger-based contacts and gestures, which are much less precise than stylus-based input due to the larger area of contact of a finger on the touch screen. In some embodiments, the device translates the rough finger-based input into a precise pointer/cursor position or command for performing the actions desired by the user.

A touch-sensitive display in some embodiments of the display system 112 may be as described in the following applications: (1) U.S. patent application Ser. No. 11/381,313, “Multipoint Touch Surface Controller,” filed on May 2, 2006; (2) U.S. patent application Ser. No. 10/840,862, “Multipoint Touchscreen,” filed on May 6, 2004; (3) U.S. patent application Ser. No. 10/903,964, “Gestures For Touch Sensitive Input Devices,” filed on Jul. 30, 2004; (4) U.S. patent application Ser. No. 11/048,264, “Gestures For Touch Sensitive Input Devices,” filed on Jan. 31, 2005; (5) U.S. patent application Ser. No. 11/038,590, “Mode-Based Graphical User Interfaces For Touch Sensitive Input Devices,” filed on Jan. 18, 2005; (6) U.S. patent application Ser. No. 11/228,758, “Virtual Input Device Placement On A Touch Screen User Interface,” filed on Sep. 16, 2005; (7) U.S. patent application Ser. No. 11/228,700, “Operation Of A Computer With A Touch Screen Interface,” filed on Sep. 16, 2005; (8) U.S. patent application Ser. No. 11/228,737, “Activating Virtual Keys Of A Touch-Screen Virtual Keyboard,” filed on Sep. 16, 2005; and (9) U.S. patent application Ser. No. 11/367,749, “Multi-Functional Hand-Held Device,” filed on Mar. 3, 2006. All of these applications are incorporated by reference herein in their entirety.

In some embodiments, in addition to the touch screen, the device 100 may include a touchpad (not shown) for activating or deactivating particular functions. In some embodiments, the touchpad is a touch-sensitive area of the device that, unlike the touch screen, does not display visual output. The touchpad may be a touch-sensitive surface that is separate from the touch screen 112 or an extension of the touch-sensitive surface formed by the touch screen.

In some embodiments, the device 100 may include a click wheel as an input control device 116. A user may navigate among and interact with one or more graphical objects (henceforth referred to as icons) displayed in the touch screen 112 by rotating the click wheel or by moving a point of contact with the click wheel (e.g., where the amount of movement of the point of contact is measured by its angular displacement with respect to a center point of the click wheel. The click wheel may also be used to select one or more of the displayed icons. For example, the user may press down on at least a portion of the click wheel or an associated physical button. User commands and navigation commands provided by the user via the click wheel may be processed by an input controller 160 as well as one or more of the modules and/or sets of instructions in memory 102.

The device 100 also includes a power system 162 for powering the various components. The power system 162 may include a power management system, one or more power sources (e.g., battery, alternating current (AC)), a recharging system, a power failure detection circuit, a power converter or inverter, a power status indicator (e.g., a light-emitting diode (LED)) and any other components associated with the generation, management and distribution of power in portable electronic devices.

The device 100 may also include one or more optical sensors 164. FIG. 1 shows an optical sensor coupled to an optical sensor controller 158 in I/O subsystem 106. The optical sensor 164 may include charge-coupled device (CCD) or complementary metal-oxide semiconductor (CMOS) phototransistors. The optical sensor 164 receives light from the environment, projected through one or more lens, and converts the light to data representing an image. In conjunction with an imaging module 143 (also called a camera module), the optical sensor 164 may capture still images or video. In some embodiments, an optical sensor is located on the back of the device 100, opposite the touch screen display 112 on the front of the device, so that the touch screen display may be used as a viewfinder for either still and/or video image acquisition. In some embodiments, an optical sensor is located on the front of the device so that the user's image may be obtained for videoconferencing while the user views the other video conference participants on the touch screen display. In some embodiments, the position of the optical sensor 164 can be changed by the user (e.g., by rotating the lens and the sensor in the device housing) so that a single optical sensor 164 may be used along with the touch screen display for both video conferencing and still and/or video image acquisition.

The device 100 may also include one or more proximity sensors 166. FIG. 1 shows a proximity sensor 166 coupled to the peripherals interface 118. Alternately, the proximity sensor 166 may be coupled to an input controller 160 in the I/O subsystem 106. The proximity sensor 166 may perform as described in U.S. patent application Ser. No. 11/241,839, “Proximity Detector In Handheld Device,” filed Sep. 30, 2005, and Ser. No. 11/240,788, “Proximity Detector In Handheld Device,” filed Sep. 30, 2005, which are hereby incorporated by reference in their entirety. In some embodiments, the proximity sensor turns off and disables the touch screen 112 when the multifunction device is placed near the user's ear (e.g., when the user is making a phone call). In some embodiments, the proximity sensor keeps the screen off when the device is in the user's pocket, purse, or other dark area to prevent unnecessary battery drainage when the device is a locked state.

In some embodiments, the software components stored in memory 102 may include an operating system 126, a communication module (or set of instructions) 128, a contact/motion module (or set of instructions) 130, a graphics module (or set of instructions) 132, a text input module (or set of instructions) 134, a Global Positioning System (GPS) module (or set of instructions) 135, and applications (or set of instructions) 136.

The operating system 126 (e.g., Darwin, RTXC, LINUX, UNIX, OS X, WINDOWS, or an embedded operating system such as VxWorks) includes various software components and/or drivers for controlling and managing general system tasks (e.g., memory management, storage device control, power management, etc.) and facilitates communication between various hardware and software components.

The communication module 128 facilitates communication with other devices over one or more external ports 124 and also includes various software components for handling data received by the RF circuitry 108 and/or the external port 124. The external port 124 (e.g., Universal Serial Bus (USB), FIREWIRE, etc.) is adapted for coupling directly to other devices or indirectly over a network (e.g., the Internet, wireless LAN, etc.). In some embodiments, the external port is a multi-pin (e.g., 30-pin) connector that is the same as, or similar to and/or compatible with the 30-pin connector used on iPod (trademark of Apple Computer, Inc.) devices.

The contact/motion module 130 may detect contact with the touch screen 112 (in conjunction with the display controller 156) and other touch sensitive devices (e.g., a touchpad or click wheel). The contact/motion module 130 includes various software components for performing various operations related to detection of contact, such as determining if contact has occurred, determining if there is movement of the contact and tracking the movement across the touch screen 112, and determining if the contact has been broken (i.e., if the contact has ceased). Determining movement of the point of contact may include determining speed (magnitude), velocity (magnitude and direction), and/or an acceleration (a change in magnitude and/or direction) of the point of contact. These operations may be applied to single contacts (e.g., one finger contacts) or to multiple simultaneous contacts (e.g., “multitouch”/multiple finger contacts). In some embodiments, the contact/motion module 130 and the display controller 156 also detects contact on a touchpad. In some embodiments, the contact/motion module 130 and the controller 160 detects contact on a click wheel 116.

The graphics module 132 includes various known software components for rendering and displaying graphics on the touch screen 112, including components for changing the intensity of graphics that are displayed. As used herein, the term “graphics” includes any object that can be displayed to a user, including without limitation text, web pages, icons (such as user-interface objects including soft keys), digital images, videos, animations and the like. An animation in this context is a display of a sequence of images that gives the appearance of movement, and informs the user of an action that has been performed (such as moving an email message to a folder). In this context, a respective animation that confirms an action by the user of the device typically takes a predefined, finite amount of time, typically between 0.2 and 1.0 seconds, and generally less than two seconds.

The text input module 134, which may be a component of graphics module 132, provides soft keyboards for entering text in various applications (e.g., contacts 137, e-mail 140, IM 141, blogging 142, browser 147, and any other application that needs text input).

The GPS module 135 determines the location of the device and provides this information for use in various applications (e.g., to telephone 138 for use in location-based dialing, to camera 143 and/or blogger 142 as picture/video metadata, and to applications that provide location-based services such as weather widgets, local yellow page widgets, and map/navigation widgets).

The applications 136 may include the following modules (or sets of instructions), or a subset or superset thereof:
a contacts module 137 (sometimes called an address book or contact list);
a telephone module 138;
a video conferencing module 139;
an e-mail client module 140;
an instant messaging (IM) module 141;
a blogging module 142;
a camera module 143 for still and/or video images;
an image management module 144;
a video player module 145;
a music player module 146;
a browser module 147;
a calendar module 148;
widget modules 149, which may include weather widget 149-1, stocks widget 149-2, calculator widget 149-3, alarm clock widget 149-4, dictionary widget 149-5, and other widgets obtained by the user, as well as user-created widgets 149-6;
widget creator module 150 for making user-created widgets 149-6; and/or
search module 151.

Examples of other applications 136 that may be stored in memory 102 include memo pad and other word processing applications, JAVA-enabled applications, encryption, digital rights management, voice recognition, and voice replication.

Note that the above identified modules and applications correspond to a set of instructions for performing one or more functions described above. These modules (i.e., sets of instructions) need not be implemented as separate software programs, procedures or modules, and thus various subsets of these modules may be combined or otherwise re-arranged in various embodiments. In some embodiments, memory 102 may store a subset of the modules and data structures identified above. Furthermore, memory 102 may store additional modules and data structures not described above.

In some embodiments, the device 100 is a device where operation of a predefined set of functions on the device is performed exclusively through a touch screen 112 and/or a touchpad. By using a touch screen and/or a touchpad as the primary input/control device for operation of the device 100, the number of physical input/control devices (such as pushbuttons, dials, and the like) on the device 100 may be reduced.

The predefined set of functions that may be performed exclusively through a touch screen and/or a touchpad include navigation between user interfaces. In some embodiments, the touchpad, when touched by the user, navigates the device 100 to a main, home, or root menu from any user interface that may be displayed on the device 100. In such embodiments, the touchpad may be referred to as a “menu button.” In some other embodiments, the menu button may be a physical push button or other physical input/control device instead of a touchpad.

FIG. 2 illustrates a portable electronic device 100 having a touch screen 112 in accordance with some embodiments. The touch screen may display one or more graphics. In this embodiment, as well as others described below, a user may select one or more of the graphics by making contact or touching the graphics, for example, with one or more fingers 202 (not drawn to scale in the figure) or a stylus (not shown in the figure). In some embodiments, selection of one or more graphics occurs when the user breaks contact with the one or more graphics. In some embodiments, the contact may include a gesture, such as one or more taps, one or more swipes (from left to right, right to left, upward and/or downward and/or a rolling of a finger (from right to left, left to right, upward and/or downward) that has made contact with the device 100. In some embodiments, inadvertent contact with a graphic may not select the graphic. For example, a swipe gesture with that sweeps over an application icon may not select the corresponding application when the gesture corresponding to selection is a tap. In other words, the portable electronic device 100 interprets the meaning of a gesture and acts accordingly after considering which application or module is being used at the moment.

The device 100 may also include one or more physical buttons, such as “home” or menu button 204. As described previously, the menu button 204 may be used to navigate to any application 136 in a set of applications that may be executed on the device 100. Alternatively, in some embodiments, the menu button is implemented as a soft key in a GUI in touch screen 112.

In one embodiment, the device 100 includes a touch screen 112, a menu button 204, a push button 206 for powering the device on/off and locking the device, and volume adjustment button(s) 208. The push button 206 may be used to turn the power on/off on the device by depressing the button and holding the button in the depressed state for a predefined time interval; to lock the device by depressing the button and releasing the button before the predefined time interval has elapsed; and/or to unlock the device or initiate an unlock process. In an alternative embodiment, the device 100 also may accept verbal input for activation or deactivation of some functions through the microphone 113.

Attention is now directed towards embodiments of user interfaces (“UI”) and associated processes that may be implemented on a portable electronic device 100.

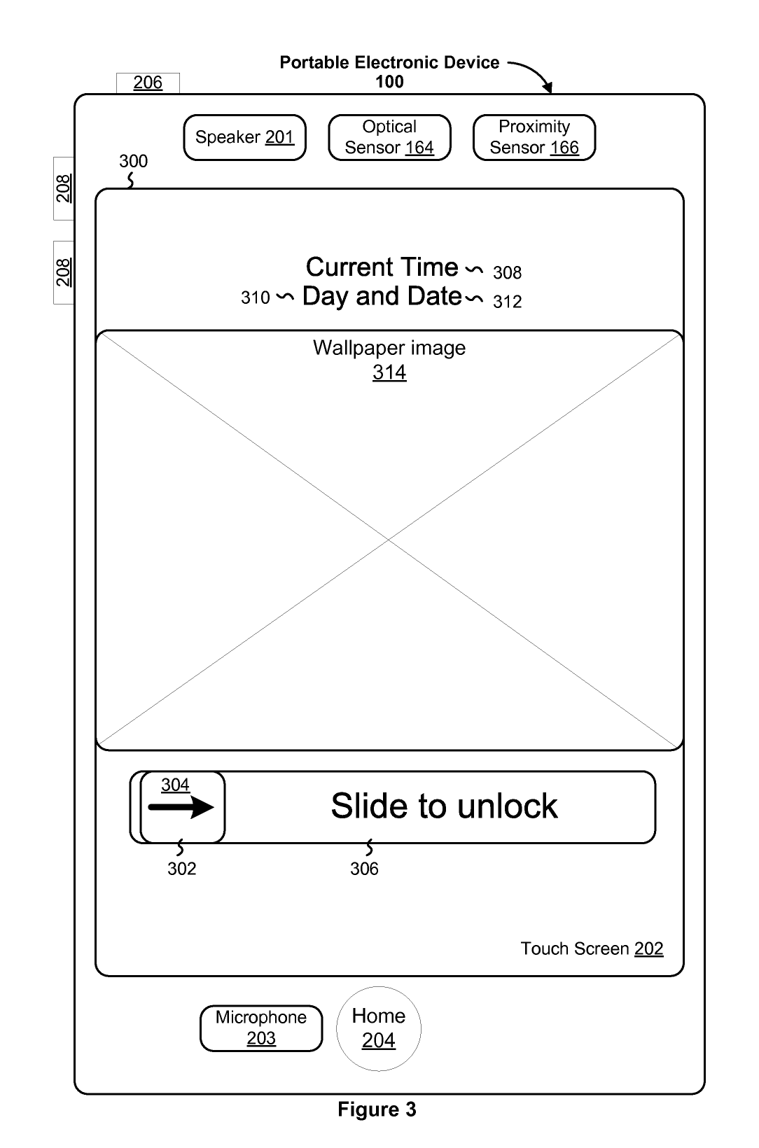

FIG. 3 illustrates an exemplary user interface for unlocking a portable electronic device in accordance with some embodiments. In some embodiments, user interface 300 includes the following elements, or a subset or superset thereof:
Unlock image 302 that is moved with a finger gesture to unlock the device;
Arrow 304 that provides a visual cue to the unlock gesture;
Channel 306 that provides additional cues to the unlock gesture;
Time 308;
Day 310;
Date 312; and
Wallpaper image 314.

In some embodiments, the device detects contact with the touch-sensitive display (e.g., a user's finger making contact on or near the unlock image 302) while the device is in a user-interface lock state. The device moves the unlock image 302 in accordance with the contact. The device transitions to a user-interface unlock state if the detected contact corresponds to a predefined gesture, such as moving the unlock image across channel 306. Conversely, the device maintains the user-interface lock state if the detected contact does not correspond to the predefined gesture. As noted above, processes that use gestures on the touch screen to unlock the device are described in U.S. patent application Ser. No. 11/322,549, “Unlocking a Device by Performing Gestures on an Unlock Image,” filed Dec. 23, 2005, which is hereby incorporated by reference in its entirety.

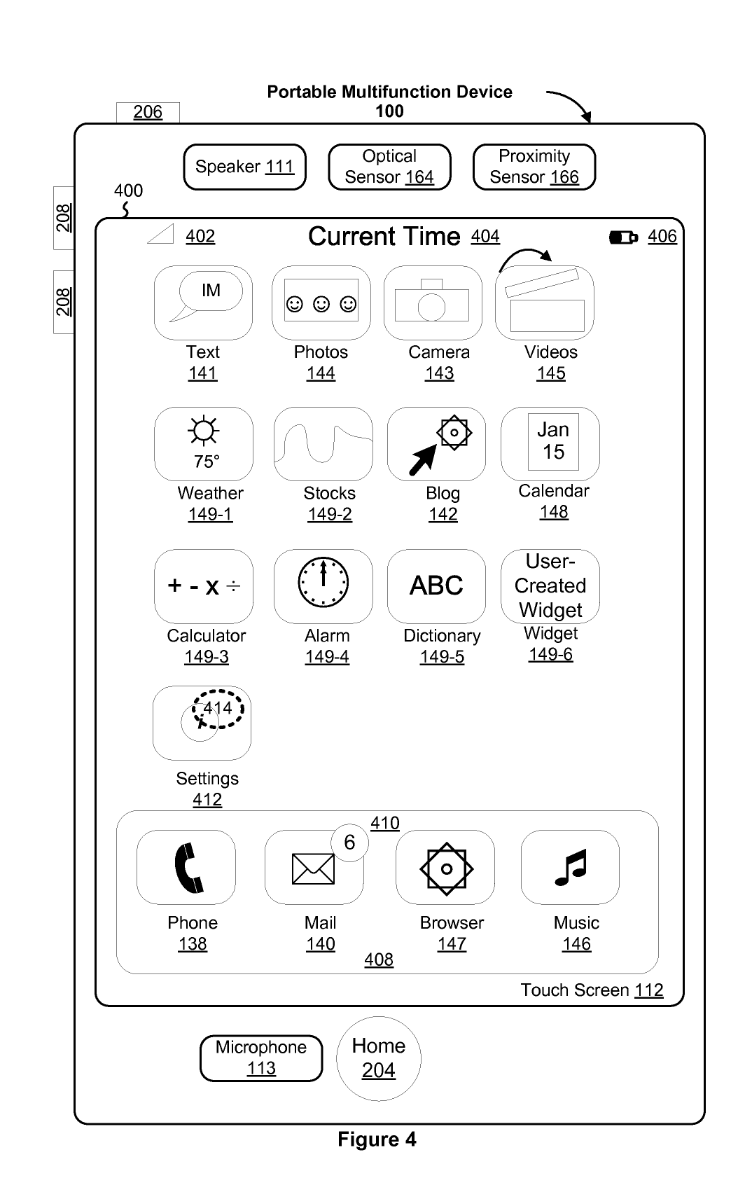

FIG. 4 illustrates an exemplary user interface for a menu of applications on a portable electronic device in accordance with some embodiments. In some embodiments, user interface 400 includes the following elements, or a subset or superset thereof:
Signal strength indicator 402 for wireless communication;
Time 404;
Battery status indicator 406;
Tray 408 with icons for frequently used applications, such as:
   Phone 138;
   E-mail client 140, which may include an indicator 410 of the number of unread e-mails;
   Browser 147; and
   Music player 146; and
Icons for other applications, such as:
   IM 141;
   Image management 144;
   Camera 143;
   Video player 145;
   Weather 149-1;
   Stocks 149-2;
   Blog 142;
   Calendar 148;
   Calculator 149-3;
   Alarm clock 149-4;
   Dictionary 149-5;
   User-created widget 149-6; and
   Settings 412.

In some embodiments, UT 400 displays all of the available applications 136 on one screen so that there is no need to scroll through a list of applications (e.g., via a scroll bar). In some embodiments, as the number of applications increase, the icons corresponding to the applications may decrease in size so that all applications may be displayed on a single screen without scrolling. In some embodiments, having all applications on one screen and a menu button enables a user to access any desired application with at most two inputs, such as activating the menu button 204 and then activating the desired application (e.g., by a tap or other finger gesture on the icon corresponding to the application).

In some embodiments, UT 400 provides integrated access to both widget-based applications and non-widget-based applications. In some embodiments, all of the widgets, whether user-created or not, are displayed in UT 400. In other embodiments, activating the icon for user-created widget 149-6 may lead to another UT (not shown) that contains the user-created widgets or icons corresponding to the user-created widgets.

In some embodiments, a user may rearrange the icons in UT 400, e.g., using processes described in U.S. patent application Ser. No. 11/459,602, “Portable Electronic Device With Interface Reconfiguration Mode,” filed Jul. 24, 2006, which is hereby incorporated by reference in its entirety. For example, a user may move application icons in and out of tray 408 using finger gestures.

In some embodiments, UT 400 includes a gauge (not shown) that displays an updated account usage metric for an account associated with usage of the device (e.g., a cellular phone account), as described in U.S. patent application Ser. No. 11/322,552, “Account Information Display For Portable Communication Device,” filed Dec. 23, 2005, which is hereby incorporated by reference in its entirety.

In some embodiments, a user may start configuring one or more application modules of the portable device 100 by first having a finger tap 414 on the settings icon 412. The portable device 100, in response, displays the application icons that correspond to applications having user-adjustable settings in a manner visually different from the applications icons that correspond to applications having no user-adjustable settings. As noted above, this feature is desired since a novice user of the device often does not know which application module(s) is user-configurable and which is not.

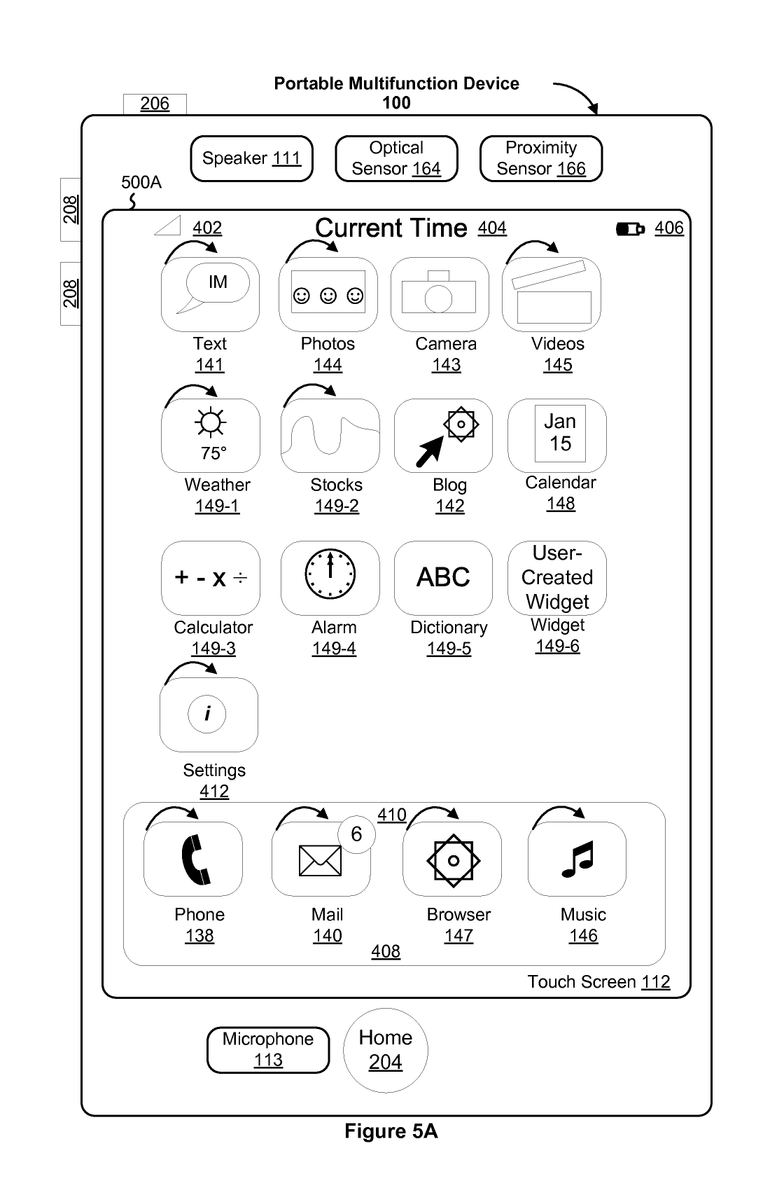

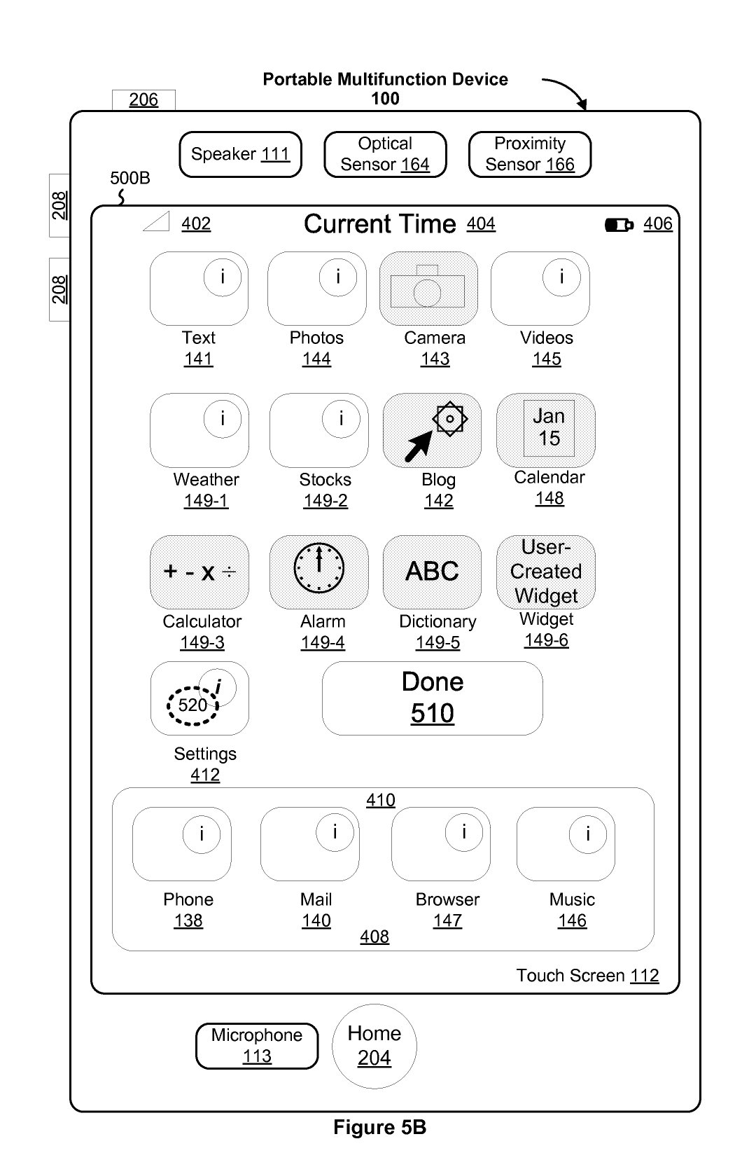

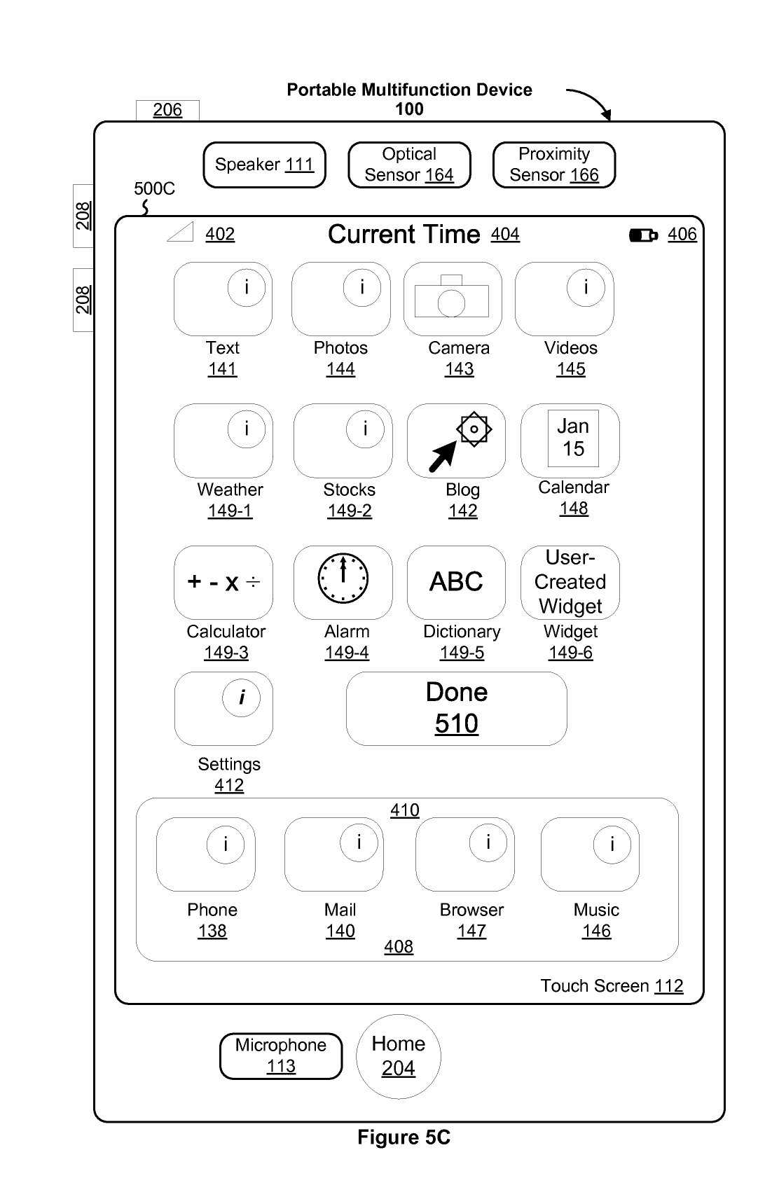

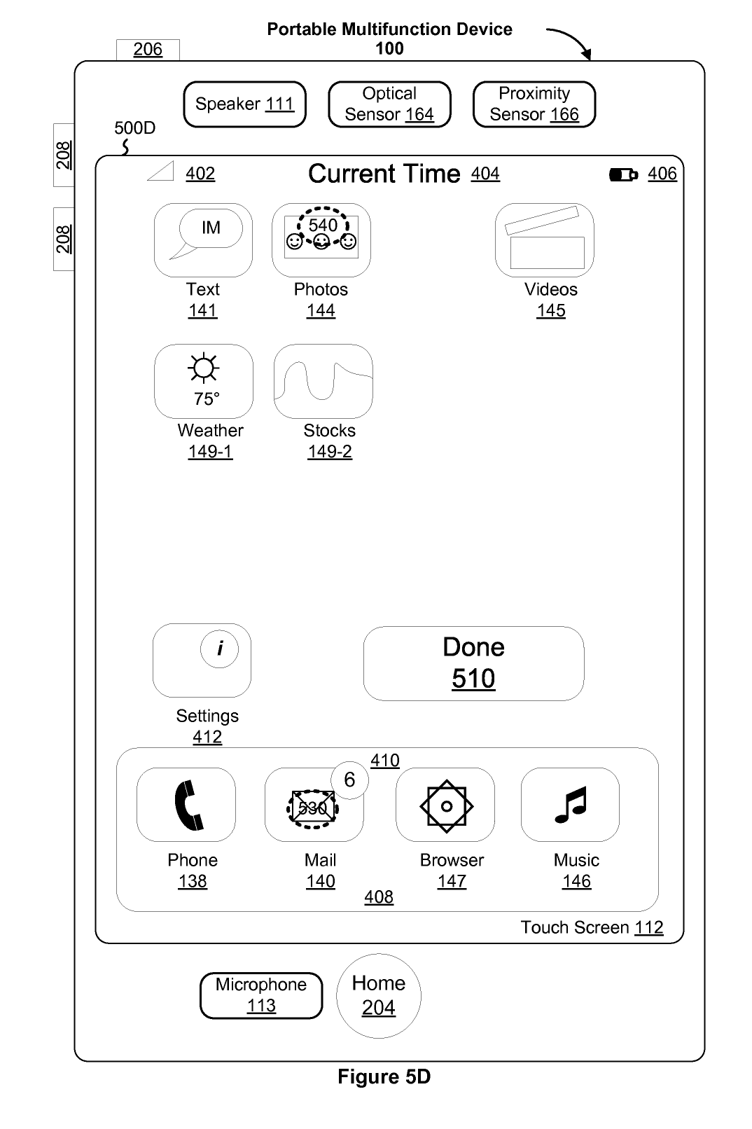

For illustrative purposes, several approaches of distinguishing the user-configurable application modules' icons from the other icons are described below in connection with FIGS. 5A through 5D. But it will be apparent for one skilled in the art to come up with other ways in the same or similar spirit.

In some embodiments, an animation is employed to differentiate the two types of application icons. Upon detecting the user selection of the settings icon 412, the portable device starts flipping the application icons corresponding to application modules having user-configurable settings from their front sides to their back sides. FIG. 5A illustrates such an exemplary user interface for flipping application icons having user-adjustable settings on a portable electronic device in accordance with some embodiments. For example, the IM icon 141, image management icon 144, video player icon 145, weather icon 149-1, and stocks icon 149-2 are being flipped over, indicating that their associated application modules have user-adjustable settings. At the same time, the camera icon 143, the blog icon 142, and the calendar icon 148 are being gradually grayed out, dimmed, or painted in a predefined color. This animation provides sufficient information to the user as to which application(s) is user configurable and which are not.

FIG. 5B illustrates an exemplary user interface for displaying both application icons with and without user-adjustable settings in visually distinguished manners on a portable electronic device in accordance with some embodiments. For example, the back side of each application icon associated with a user-configurable application module includes a small setting symbol including a letter “i”, indicating that the application module has user-adjustable settings.

In some embodiments, as shown in FIG. 5B, the back sides of the application icons corresponding to user-configurable application modules have the same appearance. A user can distinguish one from another by checking the text labels associated with different icons. In some other embodiments, besides the small setting symbol, the back side of each application icon also displays the same graphics as those shown on the front side of the icon, but in a visually different manner (e.g., grayed out).

In some embodiments, while the application icons corresponding to non-user-configurable application modules may look different from each other, all share the same visual attribute, e.g., having the same background color or being grayed out.

In some other embodiments, there is no change to the appearance of the application icons corresponding to non-user-configurable application modules while the other icons are being flipped over. FIG. 5C illustrates such an exemplary user interface for displaying application icons with user-adjustable settings in a visually distinguished manner on a portable electronic device in accordance with some embodiments. Although the camera icon 143 remains unchanged, the dynamic flipping of its neighboring icons, such as the image management icon 144 and the video player icon 145, gives a clear hint to the device's user that the camera application is not user-configurable while the image management and video players are user-configurable.

In some embodiments, the settings icon 412 is also flipped over and has a different appearance. As shown in FIGS. 5B through 5D, the setting symbol “i” (of setting icon 412) has been moved from the icon's center to its up right corner, indicating that the portable device is currently in the user configuration mode. In some embodiments, the portable device has one or more attributes that are not affiliated with a particular application or may be shared by more than one application. Exemplary attributes include time zone, wireless network access protocol, and audio volume. Another user selection 520 of this flipped settings icon 412 (FIG. 5B) causes the portable device to display a user interface listing the device's global attributes for user configuration.

In some embodiments, the user interface includes a finish icon 510 having text such as “done,” “okay,” or “save.” A user selection of this icon causes the portable device to complete the user configuration process and return to the user interface 400, shown in FIG. 4.

In some embodiments, the application icons corresponding to non-user-configurable applications are dynamically phased out from the user interface so as not to confuse the user. FIG. 5D illustrates such an exemplary user interface for displaying only application icons with user-adjustable settings on a portable electronic device in accordance with some embodiments. Application icons like the camera icon 143 and the blog icon 142, etc., are gradually removed from the user interface in response to a user selection of the settings icon 412. Finally, the user interface 500D is left with only application icons like the IM icon 141 and the weather icon 149-1, etc. In this case, flipping any of the remaining icons in the user interface becomes optional. A user can then start configuring an application by a finger tap on the corresponding application icon. For illustrative purposes, two user setting interfaces are described below. Other user setting interfaces are described in U.S. Provisional Patent Application No. 60/824,769, “Portable Multifunction Device,” the content of which is incorporated herein by reference in its entirety.

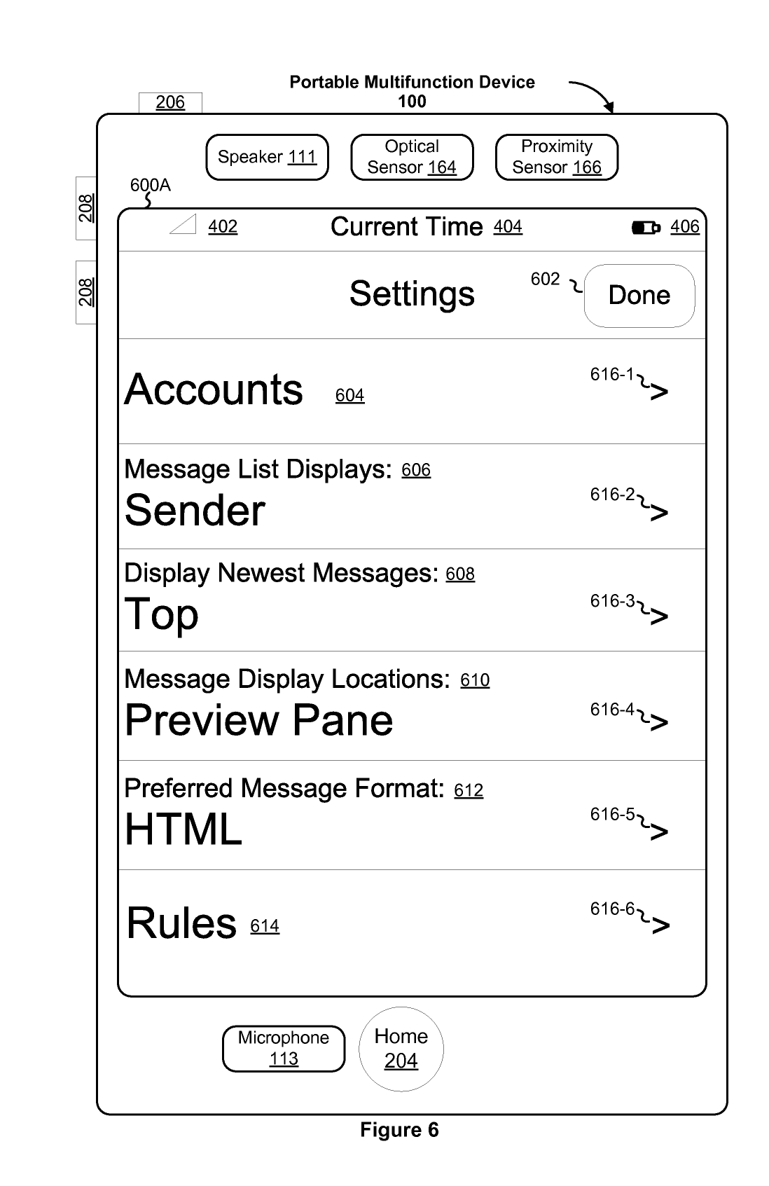

FIG. 6 illustrates an exemplary user interface for setting email user preferences in accordance with some embodiments. In some embodiments, user interface 600 includes the following elements, or a subset or superset thereof:
402, 404, and 406, as described above;
Done icon 602 that when activated (e.g., by a finger tap on the icon) returns the device to the previous UT;
Accounts 604 for entering email account information;
Message list displays 606 for selecting whether message sender and/or subject information is displayed in the emails lists;
Display newest messages 608 for selecting whether the newest messages are displayed at the top of bottom of the screen;
Message display locations 610 for selecting whether the messages are displayed in the preview pane or full screen;
Preferred message format 612 for selecting how the messages are formatted (e.g., HTML or plain text);
Rules 614 for creating rules for managing email messages;
Selection icons 616 that when activated (e.g., by a finger tap on the icon) show choices for the corresponding settings.

In some embodiments, a user may tap anywhere in the row for a particular setting to initiate display of the corresponding setting choices.

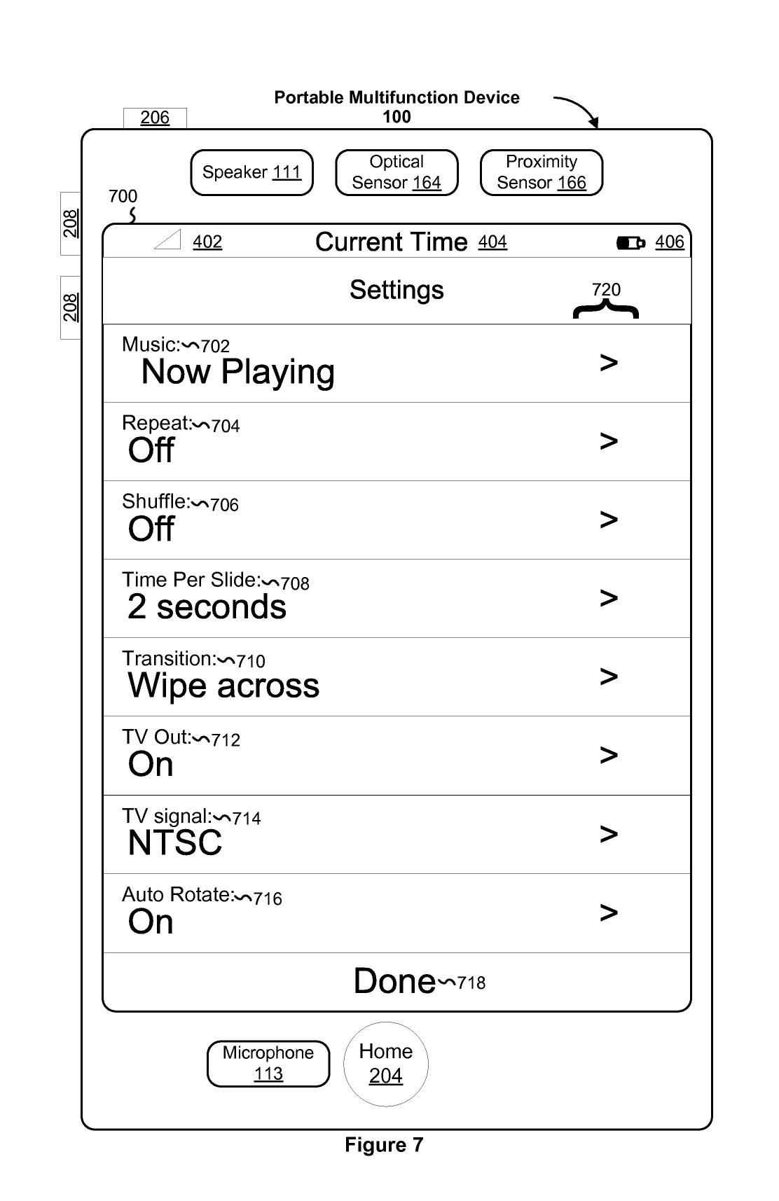

FIG. 7 illustrates an exemplary user interface for setting user preferences in accordance with some embodiments. In some embodiments, user interface 700 includes the following elements, or a subset or superset thereof:
402, 404, and 406, as described above;
Music setting 702 for selecting the music during a slide show (e.g., Now Playing, 90s Music, Recently Added, or Off);
Repeat setting 704 for selecting whether the slide show repeats (e.g., On or Off);
Shuffle setting 706 for selecting whether the images in the slide show are put in a random order (e.g., On or Off);
Time per slide setting 708 (e.g., 2, 3, 5, 10, 20 seconds or manual);
Transition setting 710 (e.g., random, wipe across, wipe down, or off);
TV out setting 712 for external display (e.g., on, off, or ask);
TV signal setting 714 (e.g., NTSC or PAL);
Auto Rotate setting 716 (e.g. on or off);
Done icon 718 that when activated (e.g., by a finger tap on the icon) returns the device to the photo album UT; and
Selection icons 720 that when activated (e.g., by a finger tap on the icon) show choices for the corresponding settings.

In some embodiments, a user may tap anywhere in the row for a particular setting to initiate display of the corresponding setting choices.

In some embodiments, a setting attribute may appear in both the global setting UT associated with the settings icon 412 and a particular setting UT associated with an application module. In this case, the user's choice through the particular setting UT overwrites the user's choice through the global setting UT when the specific application module is activated. The user's choice through the global setting UT is the default value for other applications that include the same setting attribute.

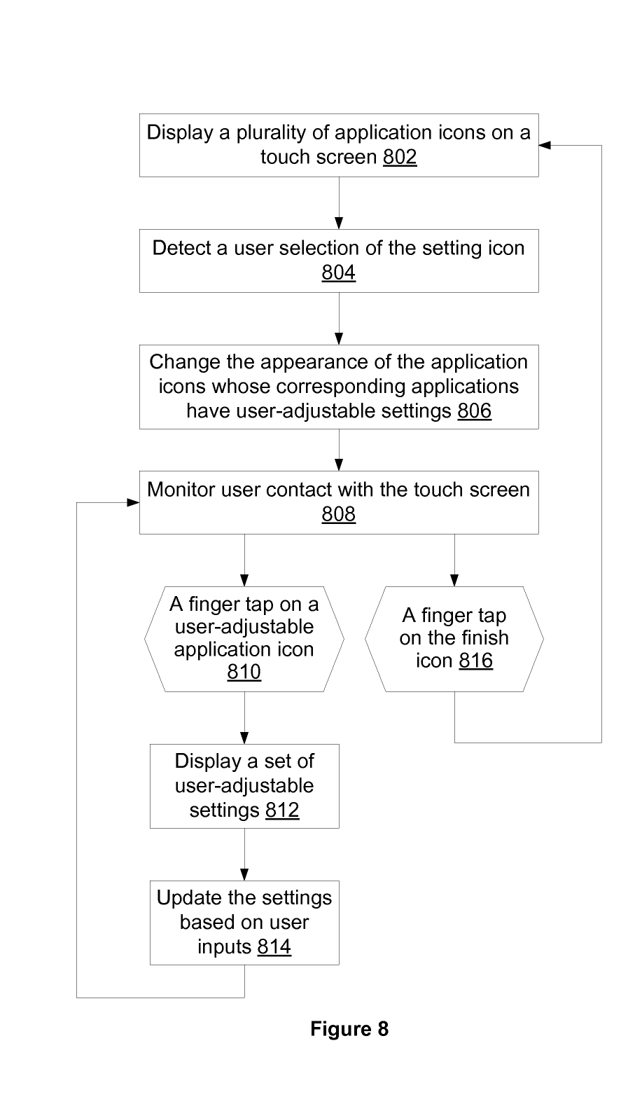

FIG. 8 is a flowchart illustrating a process for rendering user setting interfaces on a portable electronic device's touch screen in accordance with some embodiments. Initially, the portable device displays a plurality of application icons on its touch screen (802). Upon detecting a user selection of the settings icon (804), the portable electronic device changes the appearance of the application icons whose corresponding applications have user-adjustable settings (806). In some embodiments, the portable device also changes the appearance of the application icons whose corresponding applications have no user-adjustable settings. In some other embodiments, the portable device removes the application icons whose corresponding applications have no user-adjustable settings from the touch screen and leaves only the application icons whose corresponding applications have user-adjustable settings. Next, the portable device monitors the subsequent user contact with the touch screen (808).

In response to a finger tap on an application icon corresponding to an application with a set of user-adjustable settings (810), the portable device displays the set of user-adjustable settings on the touch screen (812). Note that the user-selected application icon can be the icon of a particular application module such as the phone icon 138 or the settings icon 412. The user then configures the settings parameters in accordance with the user's preference (814). After completing the configuration, the portable device returns to monitor next user contact with the touch screen (808). But if the finger tap happens on the finish icon 510 (816), the portable device then terminates the user configuration and brings back the application menu user interface such as UT 400.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best utilize the invention and various embodiments with various modifications as are suited to the particular use contemplated.

What is claimed is:

1. A computer-implemented method, comprising: at a portable multifunction device with a touch screen display,
displaying a plurality of application icons on the touch screen display, wherein some of the application icons correspond to applications that have user-adjustable settings and some of the application icons correspond to application that have no user-adjustable settings;
in response to a first gesture on the touch screen display,
changing in a first manner the appearance of the application icons whose corresponding applications have user-adjustable settings, and
changing in a second manner that is different from the first manner the appearance of the application icons whose corresponding applications have no user-adjustable settings;
displaying user-adjustable settings of an application that corresponds to an application icon in response to a second gesture on the application icon;
changing one or more of the user-adjustable settings of the application that corresponds to the selected application icon in response to one or more additional gestures to change one or more settings of the application; and
changing the appearance of the plurality of application icons to a predefined display state in response to a finishing gesture on the touch screen display.

2. A computer-implemented method, comprising: at a portable multifunction device with a touch screen display,
displaying a plurality of application icons on the touch screen display, wherein some of the application icons correspond to applications that have user-adjustable settings and some of the application icons correspond to application that have no user-adjustable settings;
changing the appearance of the application icons whose corresponding applications have user-adjustable settings upon detecting a first gesture on the touch screen display;
displaying user-adjustable settings of an application that corresponds to an application icon upon detecting a second gesture on the application icon; and
changing one or more settings of the application that corresponds to the selected application icon upon detecting one or more additional gestures to change one or more settings of the application.

3. The computer-implemented method of claim 2, wherein the first gesture is a tap gesture on a settings icon.

4. The computer-implemented method of claim 2, wherein changing the appearance of the application icons whose corresponding applications have user-adjustable settings includes an animation from a first appearance to a second appearance.

5. The computer-implemented method of claim 4, wherein the animation includes, for each application icon of the application icons whose corresponding applications have user-adjustable settings, transitioning from a first side of the application icon to a second side of the application icon.

6. The computer-implemented method of claim 5, wherein the first side is a front side and the second side is a back side.

7. The computer-implemented method of claim 2, wherein changing the appearance of the application icons whose corresponding applications have user-adjustable settings includes displaying a symbol on each such icon.

8. The computer-implemented method of claim 7, wherein the symbol includes the letter “i”.

9. The computer-implemented method of claim 2, including changing the appearance of the application icons whose corresponding applications have no user-adjustable settings upon detecting the first gesture.

10. The computer-implemented method of claim 9, wherein changing the appearance of the application icons whose corresponding applications have no user-adjustable settings includes graying out, dimming, phasing out, or removing such icons from the touch screen display.

11. The computer-implemented method of claim 2, wherein the second gesture is a tap gesture on the selected application icon.

12. The computer-implemented method of claim 2, including
changing the appearance of the plurality of application icons to a predefined display state upon detecting a finishing gesture on the touch screen display.

13. The computer-implemented method of claim 12, wherein the finishing gesture is a tap gesture on a finish icon.

14. The computer-implemented method of claim 13, wherein the finish icon is a “done” icon, an “okay” icon, or a “save” icon.

15. A computer-implemented method, comprising: at a portable multifunction device with a touch screen display,
displaying a plurality of application icons on the touch screen display, wherein some of the application icons correspond to applications that have user-adjustable settings and some of the application icons correspond to application that have no user-adjustable settings;
changing the appearance of the application icons whose corresponding applications have no user-adjustable settings upon detecting a first gesture on the touch screen display;
displaying user-adjustable settings of an application that corresponds to an application icon upon detecting a second gesture on the application icon; and
changing one or more user-adjustable settings of the application that corresponds to the selected application icon upon detecting one or more additional gestures to change one or more user-adjustable settings of the application.

16. The computer-implemented method of claim 15, wherein the first gesture is a tap gesture on a settings icon.

17. The computer-implemented method of claim 15, wherein changing the appearance of the application icons whose corresponding applications have no user-adjustable settings includes an animation from a first appearance to a second appearance.

18. The computer-implemented method of claim 17, wherein the animation includes, for each application icon of the application icons whose corresponding applications have no user-adjustable settings, transitioning from a first side of the application icon to a second side of the application icon.

19. The computer-implemented method of claim 18, wherein the first side is a front side and the second side is a back side.

20. The computer-implemented method of claim 15, wherein changing the appearance of the application icons whose corresponding applications have no user-adjustable settings includes graying out, dimming, phasing out, or removing such icons from the touch screen display.

21. The computer-implemented method of claim 15, including changing the appearance of the application icons whose corresponding applications have user-adjustable settings upon detecting the first gesture.

22. The computer-implemented method of claim 15, wherein the second gesture is a tap gesture on the selected application icon.

23. The computer-implemented method of claim 15, including changing the appearance of the plurality of application icons to a predefined display state upon detecting a finishing gesture on the touch screen display.

24. The computer-implemented method of claim 23, wherein the finishing gesture is a tap gesture on a finish icon.

25. The computer-implemented method of claim 24, wherein the finish icon is a “done” icon, an “okay” icon, or a “save” icon.

26. A graphical user interface on a portable multifunction device with a touch screen display, comprising:
a plurality of application icons, wherein some of the application icons correspond to applications that have user-adjustable settings and some of the application icons correspond to application that have no user-adjustable settings;
wherein:
in response to a first gesture, the appearances of the application icons whose corresponding applications have user-adjustable settings are changed;
in response to a second gesture on a selected application icon whose appearance is changed, user-adjustable settings of an application that corresponds to the selected application icon are displayed; and
in response to one or more additional gestures, one or more user-adjustable settings of the application that corresponds to the selected application icon are changed.

27. A portable multifunction device, comprising:
a touch screen display;
one or more processors;
memory; and
one or more programs, wherein the one or more programs are stored in the memory and configured to be executed by the one or more processors, the programs including:
instructions for displaying a plurality of application icons on the touch screen display, wherein some of the application icons correspond to applications that have user-adjustable settings and some of the application icons correspond to application that have no user-adjustable settings;
instructions for changing the appearance of the application icons whose corresponding applications have user-adjustable settings upon detecting a first gesture on the touch screen display;
instructions for displaying user-adjustable settings of an application that corresponds to an application icon upon detecting a second gesture on the application icon; and
instructions for changing one or more settings of the application that corresponds to the selected application icon upon detecting one or more additional gestures to change one or more settings of the application.

28. The portable multifunction device of claim 27, wherein the instructions for changing the appearance of the application icons whose corresponding applications have user-adjustable settings include instructions for an animation from a first appearance to a second appearance.

29. The portable multifunction device of claim 28, wherein the animation instructions include, for each application icon of the application icons whose corresponding applications have user-adjustable settings, instructions for transitioning from a first side of the application icon to a second side of the application icon.

30. The portable multifunction device of claim 27, wherein the instructions for changing the appearance of the application icons whose corresponding applications have user-adjustable settings include instructions for displaying a symbol on each such icon.

31. The portable multifunction device of claim 27, including instructions for changing the appearance of the application icons whose corresponding applications have no user-adjustable settings upon detecting the first gesture.

32. The portable multifunction device of claim 31, wherein the instructions for changing the appearance of the application icons whose corresponding applications have no user-adjustable settings include instructions for graying out, dimming, phasing out, or removing such icons from the touch screen display.

33. The portable multifunction device of claim 27, including instructions for changing the appearance of the plurality of application icons to a predefined display state upon detecting a finishing gesture on the touch screen display.

34. A computer readable storage medium storing one or more programs comprising instructions, which when executed by a portable multifunction device with a touch screen display, cause the device to:
display a plurality of application icons on the touch screen display, wherein some of the application icons correspond to applications that have user-adjustable settings and some of the application icons correspond to application that have no user-adjustable settings;
change the appearance of the application icons whose corresponding applications have user-adjustable settings upon detecting a first gesture on the touch screen display;
display user-adjustable settings of an application that corresponds to an application icon upon detecting a second gesture on the application icon; and
change one or more settings of the application that corresponds to the selected application icon upon detecting one or more additional gestures to change one or more settings of the application.

35. The computer readable storage medium of claim 34, wherein the instructions for changing the appearance of the application icons whose corresponding applications have user-adjustable settings include instructions for an animation from a first appearance to a second appearance.

36. The computer readable storage medium of claim 35, wherein the animation instructions include, for each application icon of the application icons whose corresponding applications have user-adjustable settings, instructions for transitioning from a first side of the application icon to a second side of the application icon.

37. The computer readable storage medium of claim 34, wherein the instructions for changing the appearance of the application icons whose corresponding applications have user-adjustable settings include instructions for displaying a symbol on each such icon.

38. The computer readable storage medium of claim 34, the computer program mechanism further including instructions for changing the appearance of the application icons whose corresponding applications have no user-adjustable settings upon detecting the first gesture.

39. The computer readable storage medium of claim 38, wherein the instructions for changing the appearance of the application icons whose corresponding applications have no user-adjustable settings include instructions for graying out, dimming, phasing out, or removing such icons from the touch screen display.

40. The computer readable storage medium of claim 34, the computer program mechanism further including instructions for changing the appearance of the plurality of application icons to a predefined display state upon detecting a finishing gesture on the touch screen display.

41. A portable multifunction device with a touch screen display, comprising:
means for displaying a plurality of application icons on the touch screen display, wherein some of the application icons correspond to applications that have user-adjustable settings and some of the application icons correspond to application that have no user-adjustable settings;
means for changing the appearance of the application icons whose corresponding applications have user-adjustable settings upon detecting a first gesture on the touch screen display;
means for displaying user-adjustable settings of an application that corresponds to an application icon upon detecting a second gesture on the application icon; and
means for changing one or more settings of the application that corresponds to the selected application icon upon detecting one or more additional gestures to change one or more settings of the application.
